(19) United States
(12) Patent Application Publication
(10) Pub. No.: US 2026/0081826 A1
(43) Pub. Date: Mar. 19, 2026

(54) SYSTEMS AND METHODS FOR CONFIGURING A WEARABLE PLAYBACK DEVICE

(71) Applicant: SONOS, INC., Goleta, CA (US)

(72) Inventors: Andrew S.T. LEE, Glasgow (GB); Rory ARNOLD, Glasgow (GB); Emilie PEDERSON, Seattle, WA (US); Louise Rachel WHITAKER, Seattle, WA (US)

(21) Appl. No.: 19/331,365

(22) Filed: Sep. 17, 2025

Related U.S. Application Data
(60) Provisional application No. 63/696,578, filed on Sep. 19, 2024.

(51) Int. Cl. H04L 41/0806; H04L 9/32; H04W 12/50

(52) U.S. Cl. CPC H04L 41/0806; H04L 9/3213; H04W 12/50

(57) ABSTRACT

A computing device can be configurable to, after receiving user input directed to initiating pairing of a wearable playback device with the computing device: (i) receive, from the wearable playback device, a primary access token and an issuer token, wherein the primary access token enables the computing device to control one or more primary functions of the wearable playback device, wherein the one or more primary functions of the wearable playback device are different from one or more common functions of the wearable playback device; and (ii) transmit the issuer token over a network to cause storage of the issuer token in a data repository in association with a user account.

### CROSS-REFERENCE TO RELATED APPLICATIONS

This application claims the benefit of and priority to U.S. Provisional Patent Application No. 63/696,578, filed Sep. 19, 2024, and entitled “SYSTEMS AND METHODS FOR CONFIGURING A WEARABLE PLAYBACK DEVICE,” the contents of which are incorporated by reference herein in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D

FIG. 3F is a schematic diagram of an example voice input.

FIGS. 4A through 4D are schematic diagrams of a control device in various stages of operation in accordance with aspects of the disclosed technology.

FIG. 5 is front view of a control device.

FIG. 6 is a message flow diagram of a media playback system.

FIGS. 7 through 20 are example graphical user interface displays in accordance with the disclosed subject matter.

FIGS. 21 and 22 are example operational flow diagrams of various systems in accordance with the disclosed subject matter.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to systems and methods for configuring wearable playback devices. Wearable playback devices are portable devices that can be worn on users' bodies and that include speakers for playing media content (e.g., music, podcasts, audiobooks, etc.). Example types of wearable playback devices include earbuds, in-ear monitors, over-ear or on-ear headphones, bone conduction headphones, neckband speakers, clothing items with built-in speakers (e.g., hats or beanies), head-mounted displays/devices, audio or smart glasses, and/or others.

Many wearable playback devices are configured to wirelessly communicate with computing devices, such as smartphones, tablets, laptops, desktop computers, smartwatches, etc. These devices can serve as a control device and/or content source for the wearable playback device. For instance, a user may connect or pair a set of earbuds to a smartphone via a wireless communication protocol to establish a communication link for two-way communication. The smartphone can then send media data/content over the wireless connection to the earbuds for playback on the earbuds and/or send and receive other types of data such as telephony data or voice commands.

Wearable playback devices often utilize a pairwise, short-range, and/or peer-to-peer communication protocol to connect to control devices, such as Bluetooth, Bluetooth LE, near-field communication (NFC), infrared, Wi-Fi direct, Zigbee, and/or others. These types of communication protocols generally provide for establishing communication links between devices through a pairing process and include basic playback and/or control functionality. The use of inter-device pairwise or peer-to-peer communication protocols often limits the ability of a wearable playback device to seamlessly interact with multiple user control devices that are associated with the same user (or with the same user account or user profile).

Furthermore, conventional approaches fail to implement different access levels for connections with different control devices. For instance, where a single wearable playback device is wirelessly paired with an owner's smartphone and with a guest user's smartphone, both smartphones are typically configured with the same control or access capabilities with respect to the wearable playback device, without differentiation or higher level access for the owner's smartphone. For higher level access, the owner's smartphone possesses the ability to access settings and/or controls for the wearable playback device that are not available on a guest user's smartphone.

In some embodiments disclosed herein, management of various types of tokens and an associated token management system provide the ability to define and share access levels for different control devices. This token management system can be used with other communication protocols to provide an additional layer of configuration and/or control of the wearable playback device in addition to the functionality provided via other communication protocols. To initially configure a wearable playback device (e.g., first-time setup or after a factory reset), a control device is configurable to detect an advertisement signal emitted by the wearable playback device and present a pair notification on a user interface. After receiving user input for initiating pairing of the wearable playback device with the control device, the control device may be configurable to establish a communication link with the wearable playback device and receive a primary access token and an issuer token from the wearable playback device. The primary access token, the issuer token, and a common access token (or “guest token” described later) may be generated by the wearable playback device upon factory reset.

In some instances, in addition to common functions such as controlling playback, audio settings, and/or content selection, the primary access token can enable the control device to control primary, admin-level, or higher-level functions of the wearable playback device, such as diagnostics, voice settings, usage data access or sharing, playback device swapping (e.g., in connection with a media playback system that includes multiple playback devices organized in zones and/or areas), spatial or immersive audio settings, head tracking settings, EQ settings, personalized button settings, listening preferences, notification preferences, default playback preferences, and/or other functions.

The control device can be configurable to, after receiving the issuer token from the wearable playback device, transmit the issuer token over a network for storage in a data repository (e.g., token management system of a cloud service/system). The issuer token may be stored in association with a user account (e.g., a user account active on the control device facilitating the initial configuration of the wearable playback device). Storing the issuer token in such a manner can enable another control device on which the user account is active to obtain a primary access token from the wearable playback device (e.g., when pairing the wearable playback device with the other control device) and enable seamless sharing of access levels across different devices. For instance, the other control device on which the user account is active may acquire the issuer token from the data repository (e.g., via a request to the cloud service/system) after the user logs into her account on the other control device. After acquiring the issuer token, the other control device may request a primary access token from the wearable playback device (e.g., during pairing) to grant the other control device the same primary access level obtained by the control device used to initially configure the wearable playback device.

In some instances, a guest device or a guest control device may be paired to and/or used to control the wearable playback device. To a particular wearable device, a guest device may be a control device which is not logged into the account of the owner account or the owner account is not active on the device. An owner account may be a user account used during initial configuration of the wearable playback device. Pursuant to such pairing, a guest control device may receive a common access token from the wearable playback device, which may enable the guest control device to control common functions of the wearable playback device (e.g., playback, audio settings, and/or content selection) without enabling the guest control device to control primary functions of the wearable playback device. In some instances, a wearable playback device is configured to become paired with a predetermined quantity of control devices (e.g., up to 7 control devices), which may include guest control devices, control devices on which the user account used for initial configuration is active (e.g., “owner devices” or “owner control devices”), or a combination thereof. A control device may record in memory (e.g., cache memory) the wearable playback device(s) that has/have been paired with the control device.

The disclosed subject matter can enable wearable playback devices to seamlessly connect and/or interact with multiple user control devices that are associated with the same user (e.g., owner devices) and control devices associated with other users (e.g., guest devices), thereby providing a multi-user access framework. In some instances, the wearable playback device may be concurrently connected to multiple control devices and receive commands from multiple control devices. Advantageously, the use of primary access tokens (which can be given to the control device that initially configures a wearable playback device and to other control devices that present an issuer token) and common access tokens can facilitate differentiated access, permissions, and/or control of a wearable playback device by different user control devices.

The issuer token (e.g., stored via a cloud service/resource) can permit authorized or authenticated user control devices (e.g., control devices on which a specific user account is active) to obtain a primary access token from a wearable playback device without performing a factory reset, enabling multi-device primary access to the wearable playback device in a seamless manner. In some instances, the different types of tokens (e.g., issuer tokens, primary access tokens, common access tokens) are generated, selected, and passed among devices automatically, without user intervention, which can contribute to a smooth user experience.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

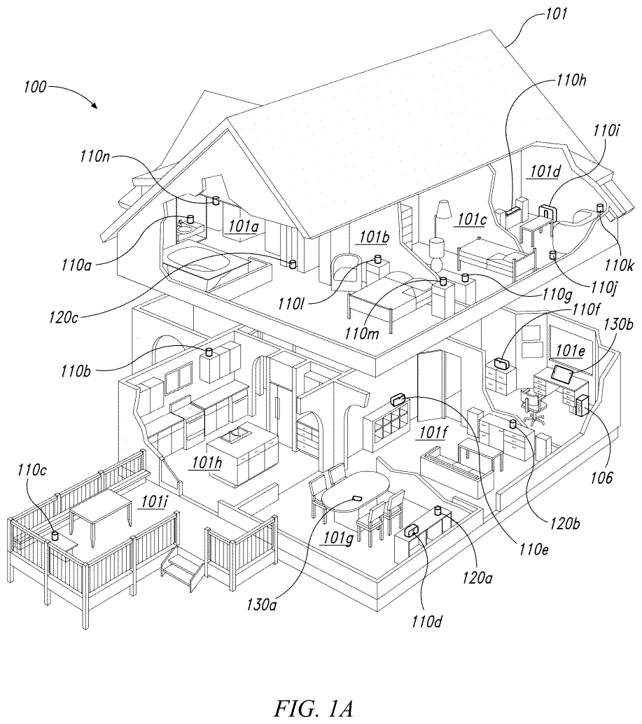

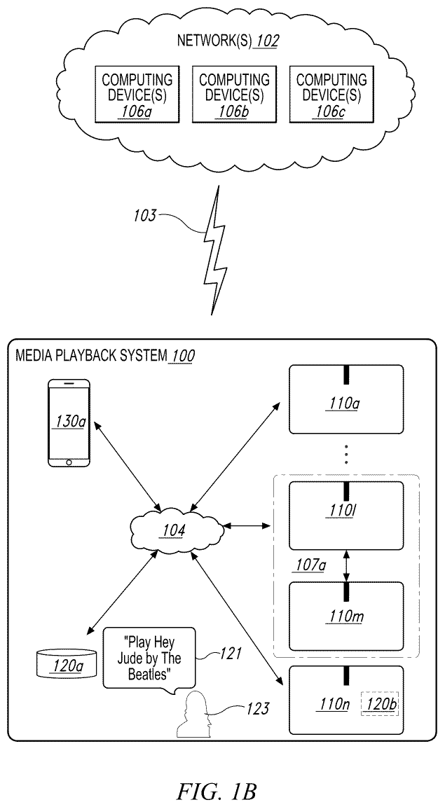

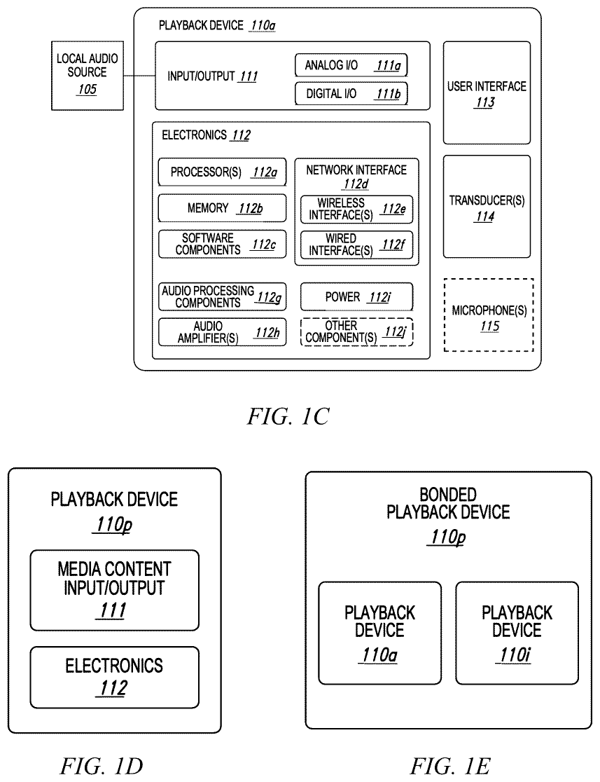

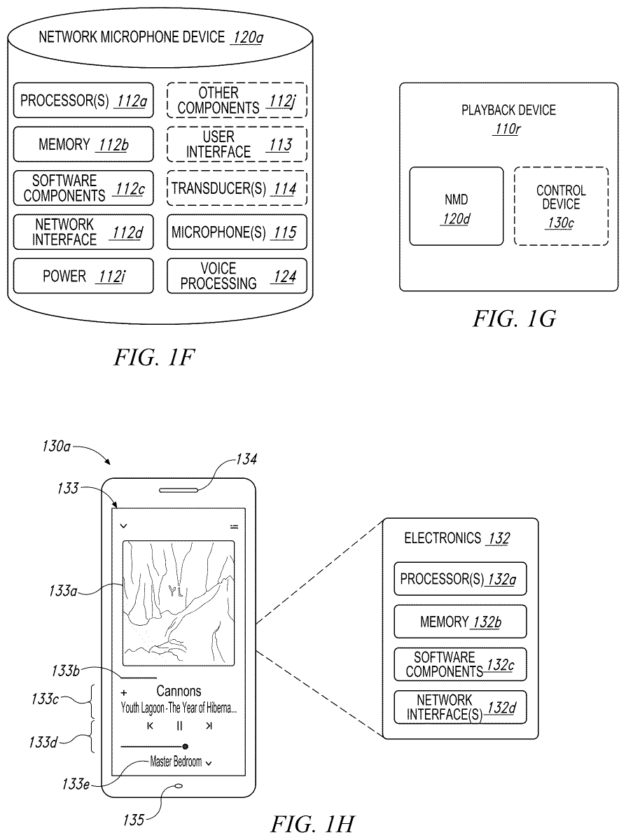

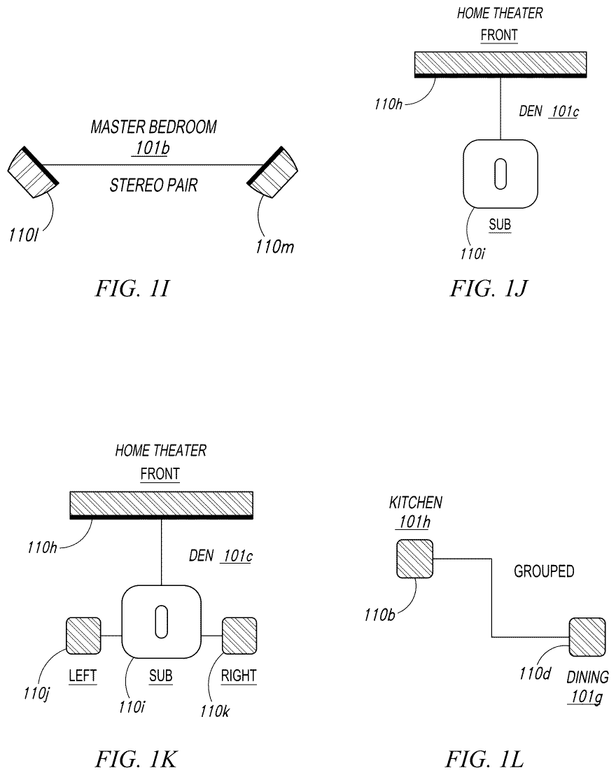

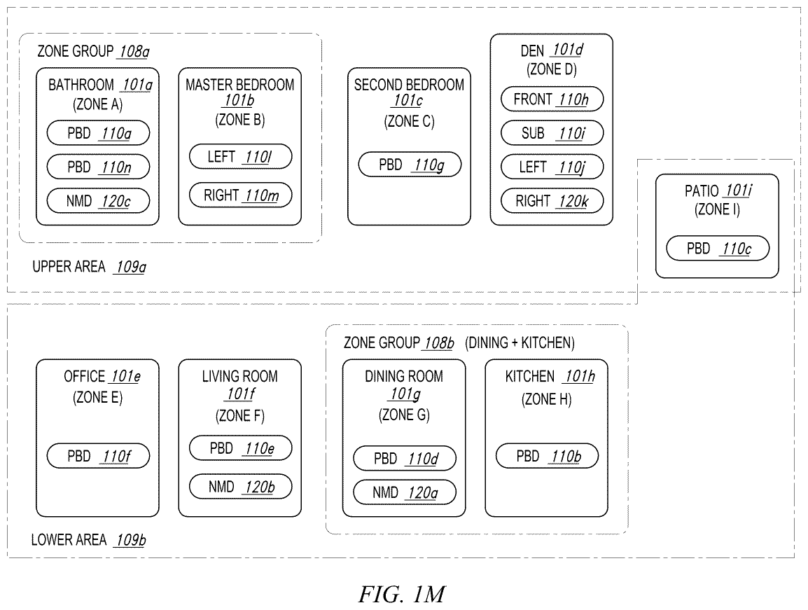

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to an electronic device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a main bathroom 101a, a main bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, main bathroom 101a, main bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the main bathroom 101a, the second bedroom 101c, the office 101e, the living room 101f, the dining room 101g, the kitchen 101h, and the outdoor patio 101i each include one playback device 110, and the main bedroom 101b and the den 101d include a plurality of playback devices 110. In the main bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a Wi-Fi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “Wi-Fi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, 6 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household Wi-Fi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. Other playback devices 110 described herein may include one or more of the components of the playback device 110a shown and described with reference to FIG. 1C. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, Wi-Fi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store program instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., Wi-Fi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises one or more wearable playback devices (e.g., earbuds, in-car monitors, over-car or on-ear headphones, bone conduction headphones, neckband speakers, clothing items with built-in speakers (e.g., hats or beanies), head-mounted displays/devices, and/or others). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114. One will appreciate, in view of the present disclosure, that a playback device 110a may omit one or more components shown and described with reference to FIG. 1C (e.g., a wearable playback device may omit a network interface 112d).

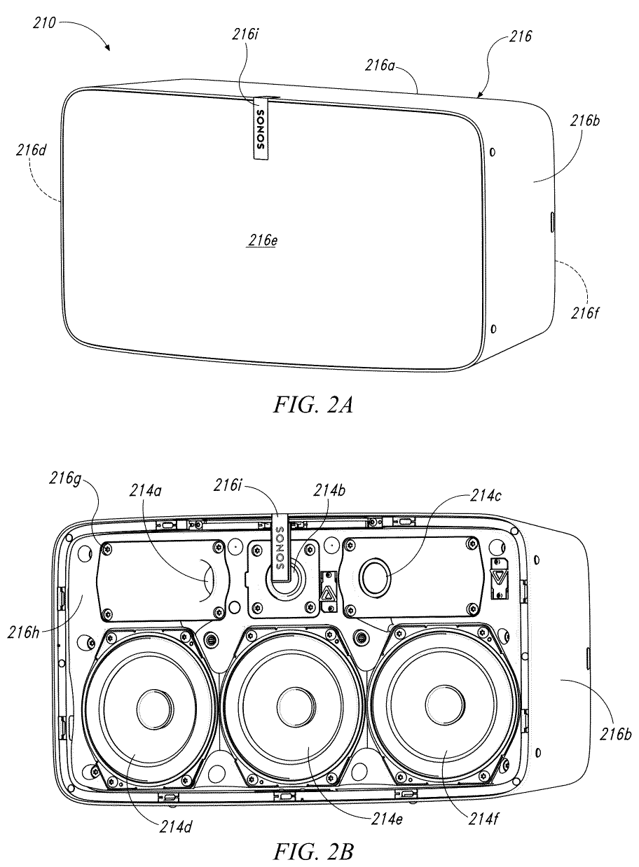

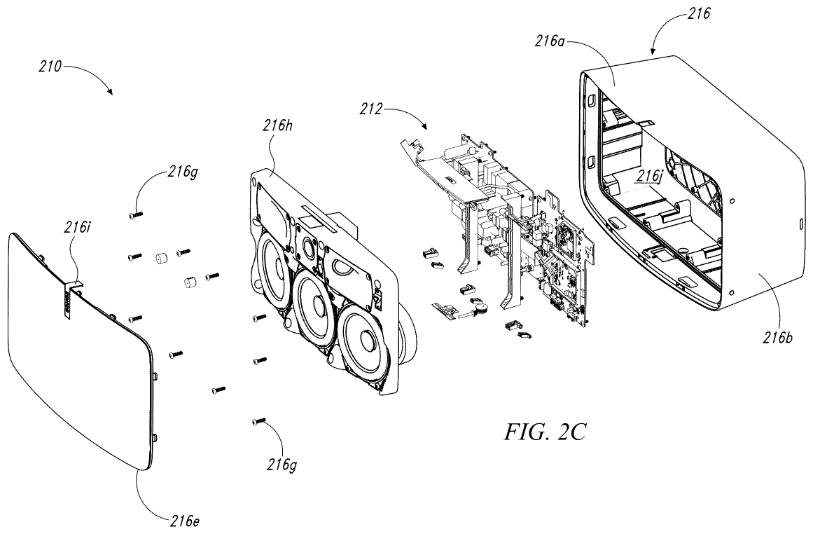

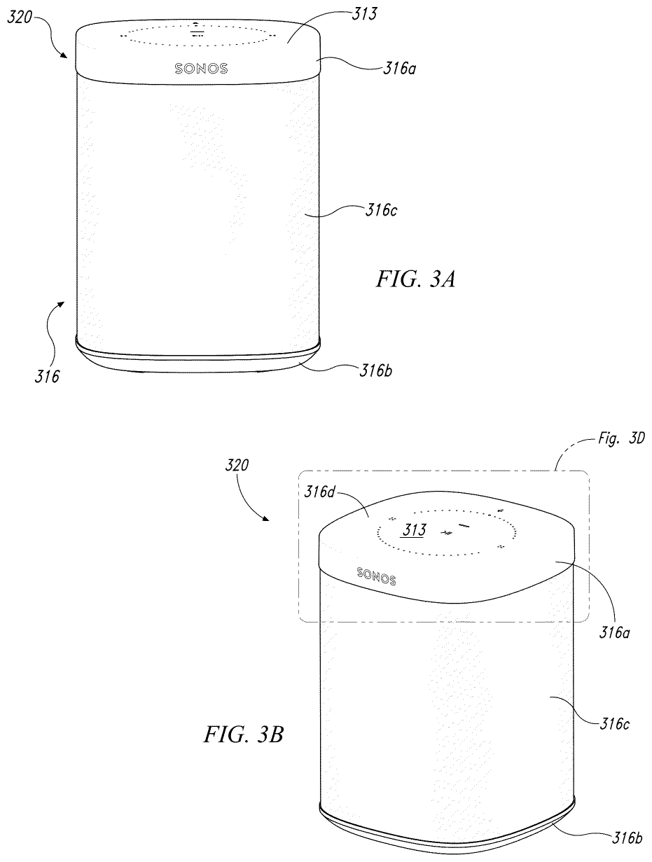

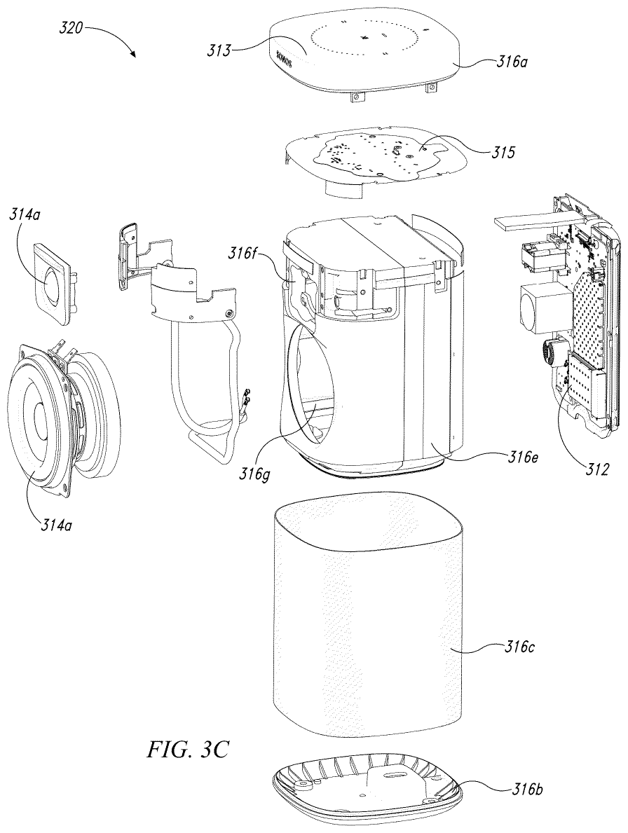

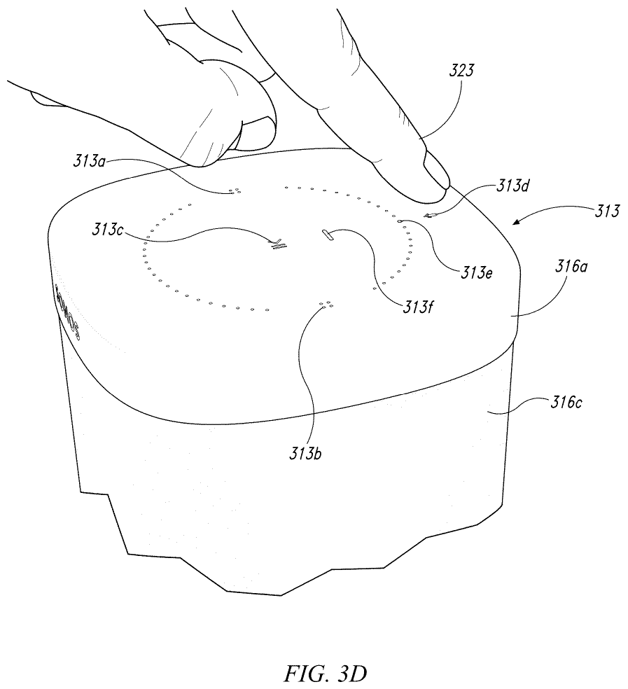

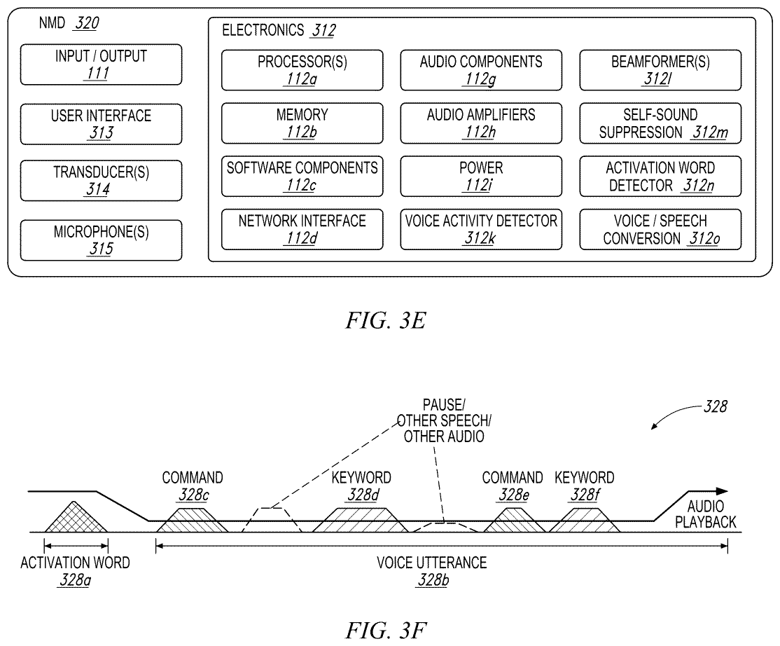

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™. an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

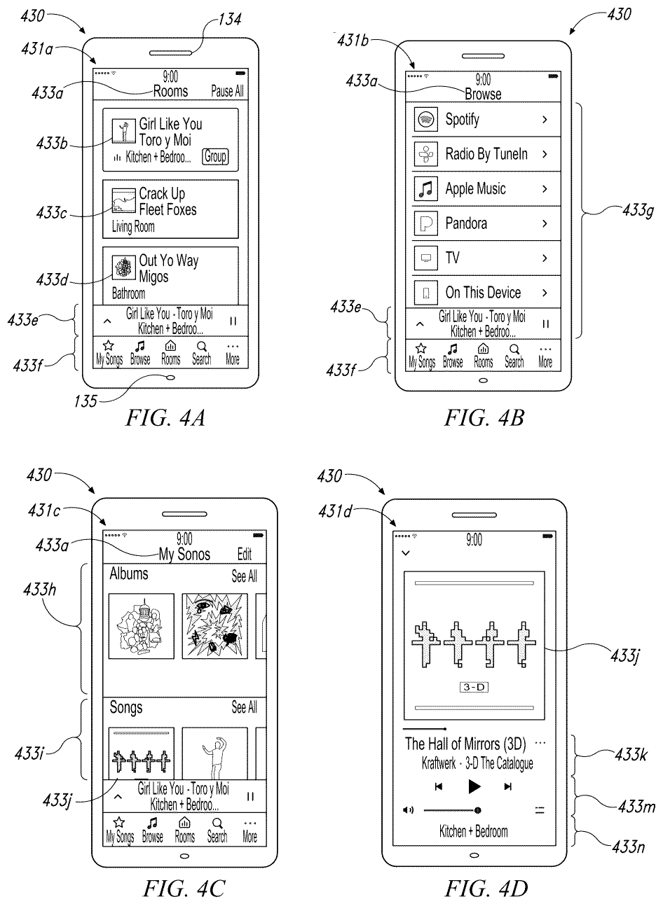

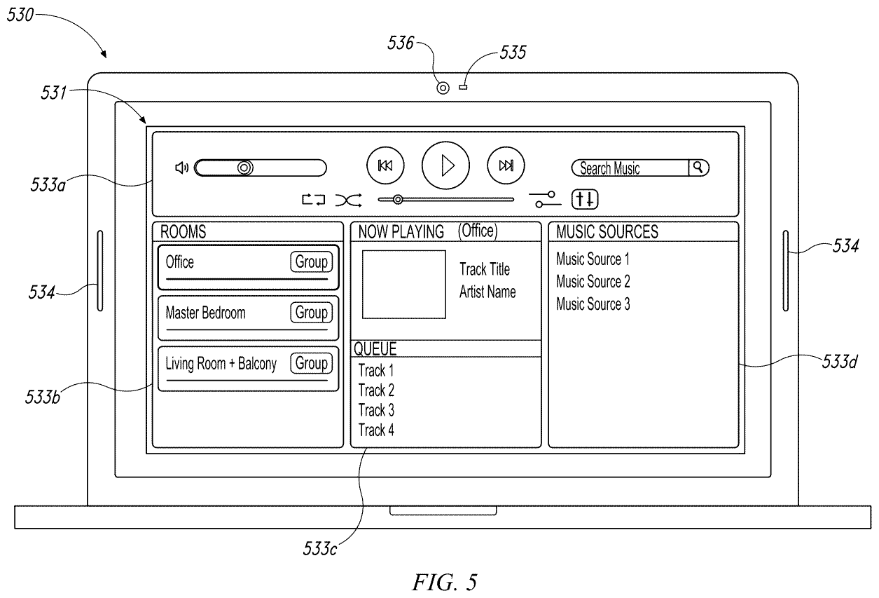

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1A through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Main Bathroom. Zone B may be provided as a single entity named Main Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the main bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have been assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media playback system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 3120 (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 557a can be a known activation word, such as “Alexa,” which is associated with AMAZON's ALEXA®. In other embodiments, however, the voice input 328 may not include an activation word. In some embodiments, a network microphone device may output an audible and/or visible response upon detection of the activation word portion 328a. In addition, or alternately, an NMB may output an audible and/or visible response after processing a voice input and/or a series of voice inputs.

The voice utterance portion 328b may include, for example, one or more spoken commands (identified individually as a first command 328c and a second command 328c) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word 557a (or activation word portion). The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433c includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by TuneIn, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533c. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

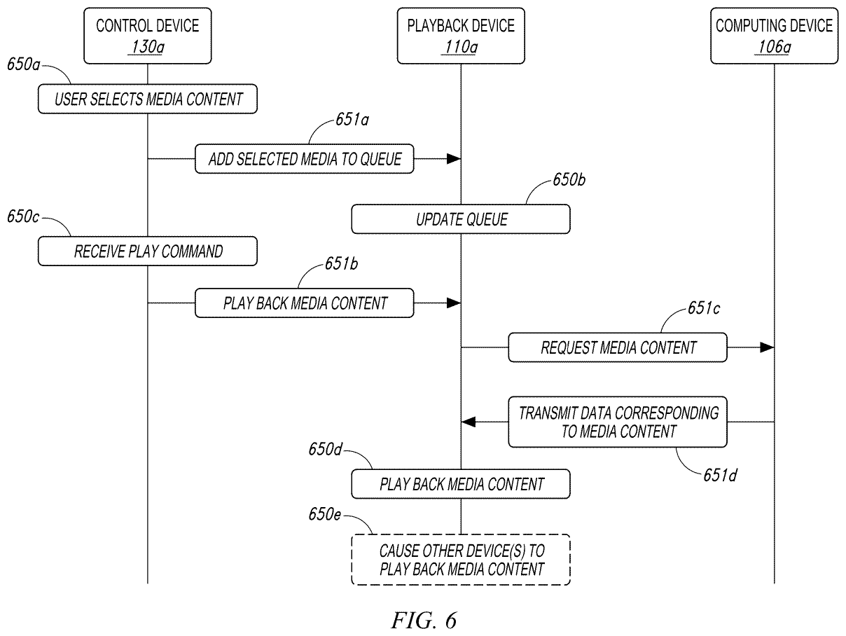

FIG. 6 is a message flow diagram illustrating data exchanges between devices of the media playback system 100 (FIGS. 1A-1M).

At block 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At block 650b, the playback device 110a receives the message 651a and adds the selected media content to the playback queue for playback.

At block 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (e.g., audio data, video data, a URL, a URI) corresponding to the requested media content.

At block 650d, the playback device 110a receives the message 651d with the data corresponding to the requested media content and plays back the associated media content.

At block 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a, and begin playback of the selected media content in response to a message from the playback device 110a such that all of the devices in the group play back the selected media content in synchrony.

In some instances, block 650e alternatively includes swapping the playback device 110a with one or more other playback devices to play back the selected media content. For instance, in response to a user command, the playback device 110a may cease or refrain from playing back the selected media content, whereas another selected playback device may begin playing back the selected media content. As an illustrative example, a user may initially begin playback of media content using one or more initial playback devices of a media playback system that includes one or more designated zones or areas. After playing back the media content for some time, the user may provide a command that causes the initial playback device(s) to be swapped with one or more other playback devices (e.g., playback devices of another zone or area, or a wearable playback device that is paired with a control device that is in communication with the media playback system) such that the other playback device(s) begin playing back the media content while the initial playback device(s) cease playing back the media content.

### IV. Configuring Wearable Playback Devices

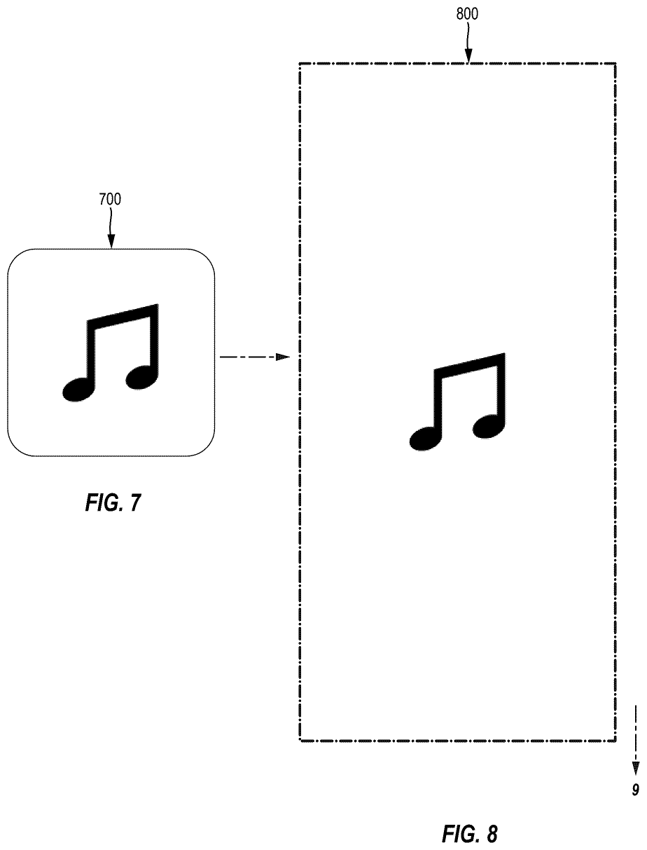

FIGS. 7 through 20 are example graphical user interface displays in accordance with the disclosed subject matter. FIG. 7 illustrates an example icon 700 that may be presented on a display of a control device (e.g., corresponding to control device 130), which may be implemented as a smartphone, tablet, laptop, or other type of electronic device. The icon 700 may be selected to trigger running of an application or executable software (e.g., a media application) stored on the control device for configuring or controlling one or more playback devices (e.g., playback devices of a media playback system 100, and/or playback devices paired with a control device). For instance, the media application may be adapted to facilitate onboarding or adding of playback devices to a media playback system, or may be able to organize added playback devices into zones, areas, and/or groups. The media application may further be able to control playback of media content using the playback device(s) associated with the media playback system. One will appreciate, in view of the present disclosure, that a media application as described herein may be launched and/or presented in manners different from those explicitly shown and described herein, and that the specific features and/or presentations of a media application may vary in different implementations.

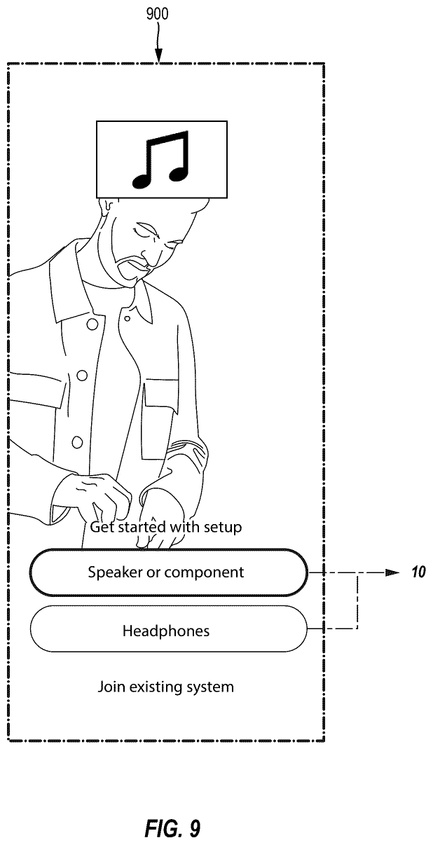

FIG. 8 illustrates an example splash screen 800 that may be presented on a display of a control device after selection of the icon 700. FIG. 8 includes a dashed arrow (with a long-short dash pattern) proximate to a reference numeral “9”, indicating that after presentation of the splash screen 800 on the display of the control device (or after a command to run the media application), the content shown in FIG. 9 may be presented on the display of the control device. As used herein, a dashed arrow and its associated reference numeral(s) (indicating the number(s) of the corresponding Figure(s) showing content that can subsequently be displayed on a control device) may be referred to as “dashed arrow X”, where X indicates the reference numeral(s).

FIG. 9 illustrates an example graphical user interface display showing an initial setup interface 900 allowing users to select a type of product to setup for media playback. For instance, the initial setup interface 900 includes a “Speaker or component” selectable element that can be selected to trigger setup of a playback device with a network interface (e.g., network interface 112d, giving the playback device direct network access) for inclusion in a media playback system. The initial setup interface 900 also includes a “Headphones” selectable element that can be selected to trigger setup of a wearable playback device, which may, in some instances, lack a network interface and instead utilize pairwise or peer-to-peer connection with a control device to perform playback and/or other functions and/or to act as part of a media playback system. Initial setup interface 900 also includes a “Join existing system” selectable element that can allow a user to login to an existing user account associated with an existing media playback system (e.g., which may skip product setup operations).

In some instances, the initial setup interface 900 is displayed on the control device (e.g., after a command to run the media application) when no user account associated with a media playback system is determined to be active or previously logged in on the control device.

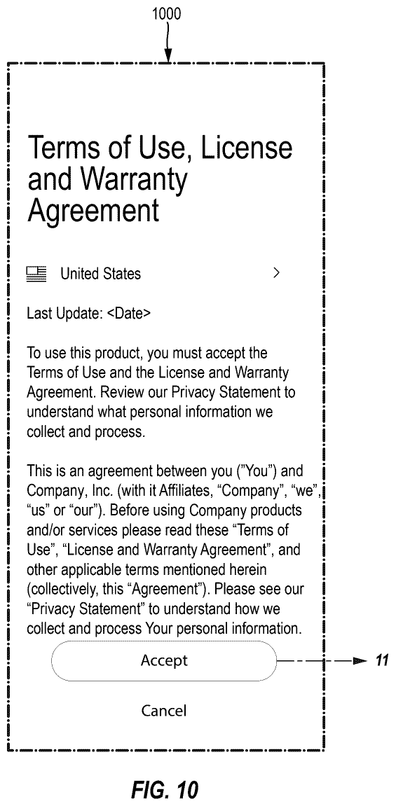

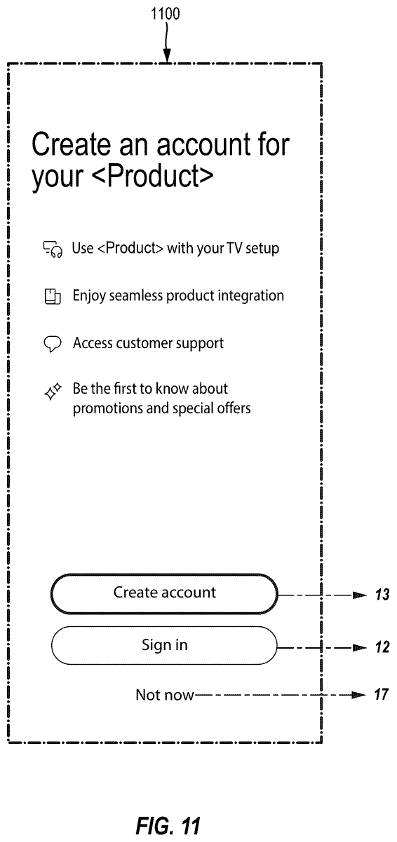

FIG. 9 illustrates dashed arrow 10 extending from the “Speaker or component” selectable element and the “Headphones” selectable element, indicating that the content shown in FIG. 10 can be presented on the control device after selection of either of these selectable elements. FIG. 10 illustrates an example graphical user interface display showing an agreement interface 1000 allowing users to accept one or more user agreements associated with use of a playback device. The agreement interface 1000 includes an “Accept” selectable element with dashed arrow 11 extending therefrom, indicating that the content of FIG. 11 can be presented on the control device after selection of the “Accept” selectable element.

FIG. 11 illustrates an example graphical user interface display showing an account interface 1100, which can enable users to create a user account (e.g., via the “Create account” selectable element), sign into an existing user account (e.g., via the “Sign in” selectable element), or proceeding without a user account (e.g., via the “Not now” selectable element). A user account may be associated with a unique identity (e.g., a username, email address, etc.) and can be securely accessed (e.g., via a password and/or other security mechanisms) to enable the media application executing on the control device to manage and/or control one or more media playback systems and/or playback devices, as described herein.

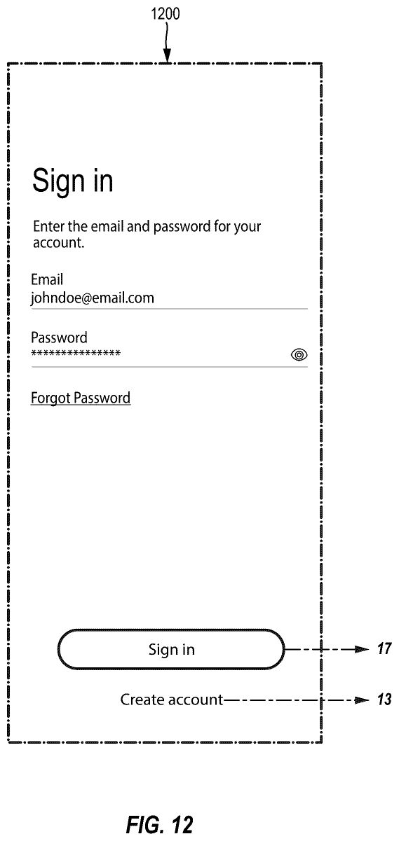

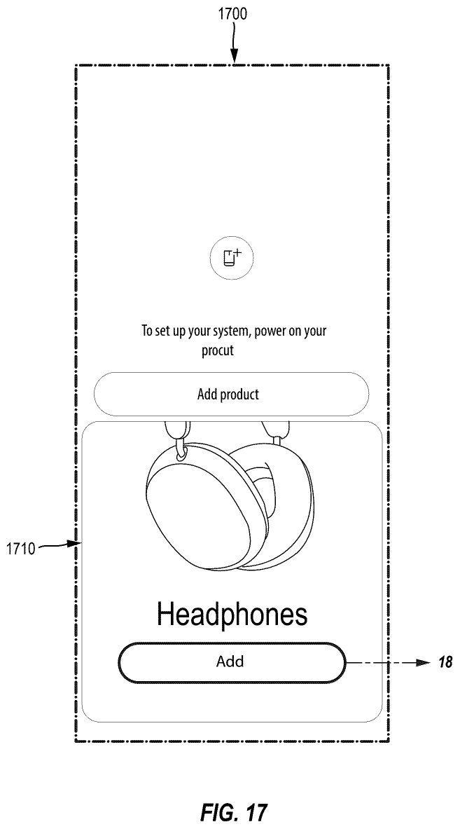

FIG. 12 illustrates an example graphical user interface display showing a sign in interface 1200, which may be presented on the control device after selection of the “Sign in” selectable element of the account interface 1100 (indicated by dashed arrow 12 in FIG. 11). In the example shown in FIG. 12, the sign in interface 1200 includes input fields for receiving an email address (e.g., labeled “Email”) and a password (e.g., labeled “Password”) associated with an existing user account. After entering a correct email address and password in the input fields, a user may select the “Sign in” selectable element shown in the sign in interface 1200 to reach a media dashboard interface or other landing page for adding playback devices or managing existing playback devices (see FIG. 17, indicated by dashed arrow 17 in FIG. 12).

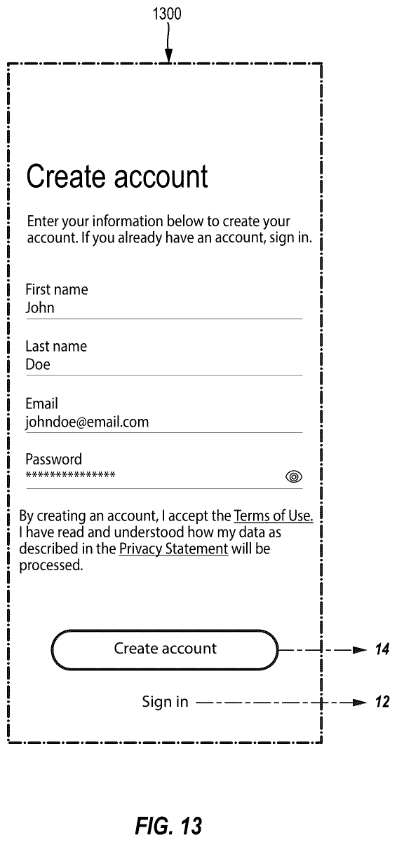

FIG. 13 illustrates an example graphical user interface display showing an account creation interface 1300, which may be presented on the control device after selection of the “Create account” selectable element of the account interface 1100 (indicated by dashed arrow 13 in FIG. 11) or after selection of the sign in interface 1200 (indicated by dashed arrow 13 in FIG. 12). In the example shown in FIG. 13, the account creation interface 1300 includes input fields for receiving a name of a user for a user account (e.g., the input fields labeled “First name” and “Last name”), an email address to associate with the user account (e.g., the input field labeled “Email”), and a password to associate with the user account (e.g., the input field labeled “Password”).

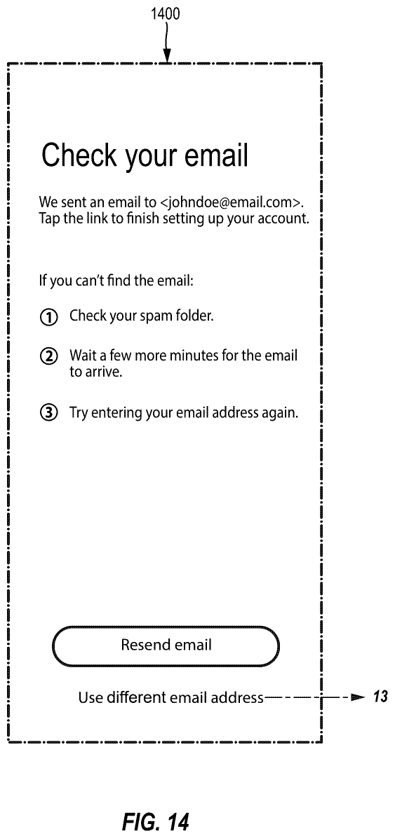

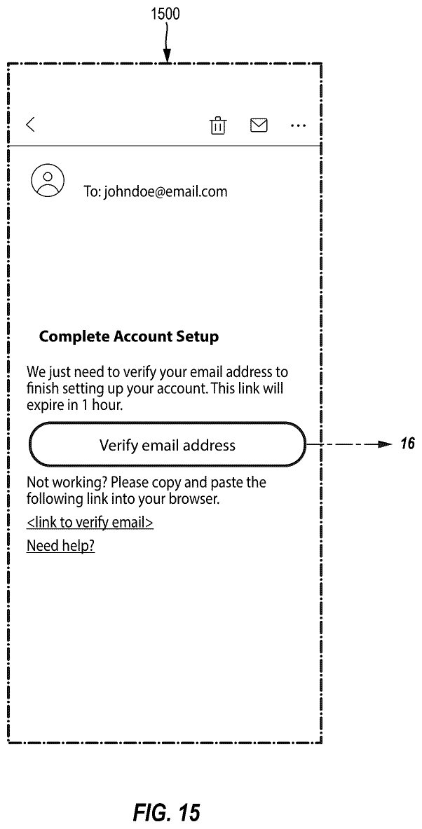

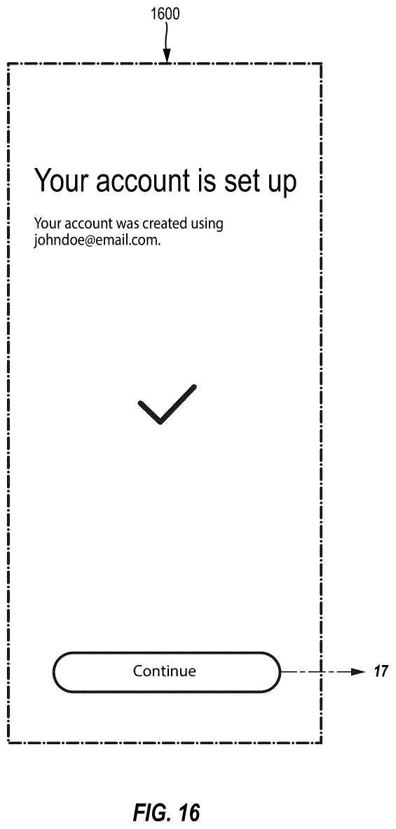

After entry of appropriate information into the input fields of the account creation interface 1300, the user may select the “Create account” selectable element to trigger an account verification process. FIG. 14 illustrates a graphical user interface display showing a verification interface 1400 indicating that a verification email has been sent to the email address designated at the “Email” field of the account creation interface 1300. FIG. 15 illustrates a graphical user interface display showing an email interface 1500 in which the verification email has been accessed, allowing the user to complete the verification process by selecting the “Verify email address” selectable element. FIG. 16 illustrates a graphical user interface display showing an account confirmation interface 1600 that communicates to the user that setup of the user account for association with one or more playback devices is complete. The account confirmation interface 1600 may be presented on a control device after selection of the “Verify email address” selectable element of the email interface 1500 (indicated by dashed arrow 16 in FIG. 15). Other verification methods or types of credentialing and/or security may be utilized for a user account within the scope of the present disclosure.

FIG. 17 illustrates a graphical user interface display showing a media dashboard interface 1700 that may be presented on the control device after setup and verification of a new user account (e.g., after selection of the “Continue” selectable element of the account confirmation interface 1600, as indicated by dashed arrow 17 in FIG. 16), after signing into an existing user account (e.g., after entry of proper credentials and selection of the “Sign in” selectable element of the interface 1200, as indicated by dashed arrow 17 in FIG. 12), or after a user electing to proceed with setting up a playback device without a user account (e.g., after selection of the “Not now” selectable element of the account interface 1100, as indicated by dashed arrow 17 in FIG. 11).

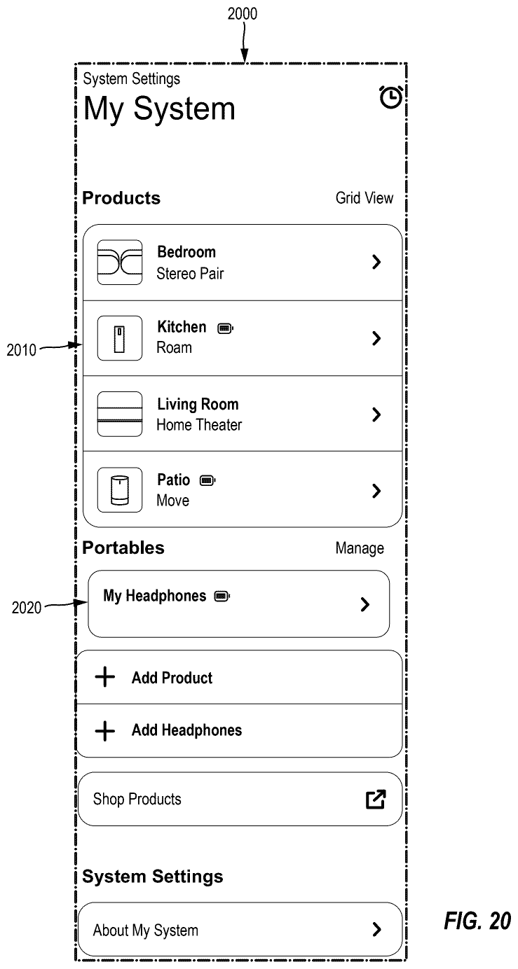

In the example shown in FIG. 17, the media dashboard interface 1700 includes an “Add product” selectable element, which may be presented to enable users to (i) add playback devices (which may include a network interface) for inclusion in the media playback system associated with the user account and/or (ii) pair wearable playback devices (which may lack a network interface) with the control device on which the user account is active. A media dashboard interface 1700 can include additional or alternative elements (e.g., see FIG. 20).

In the example shown in FIG. 17, the graphical user interface display also presents a pair notification 1710, which indicates that a wearable playback device (e.g., corresponding to playback device 110) is available for pairing with the control device. The wearable playback device depicted in FIG. 17 is a set of wireless headphones, though other types of wearable playback devices may be paired with a control device as disclosed herein.

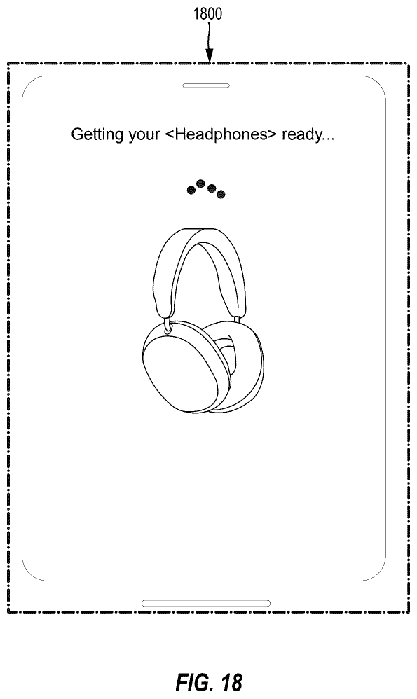

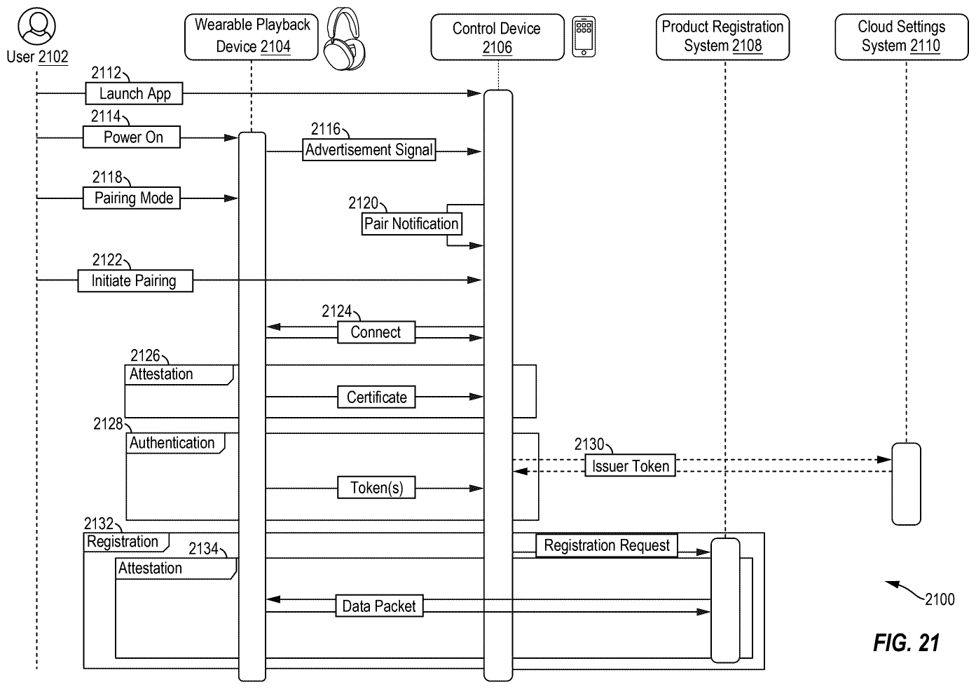

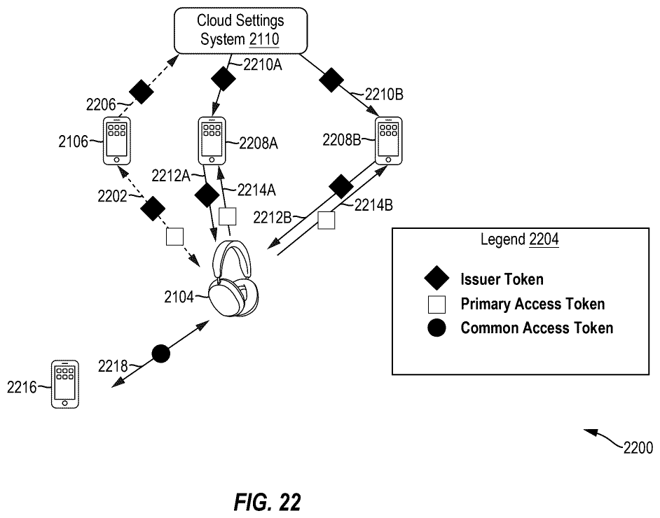

The pair notification 1710 may be presented on the control device after the control device detects an advertisement signal from the wearable playback device (e.g., when the wearable playback device is powered on and emitting an advertising signal). The pair notification 1710 shown in FIG. 17 includes an “Add” selectable element, which may be selected by users to initiate pairing of the wearable playback device with the control device. FIG. 18 illustrates a graphical user interface display showing a pairing presentation 1800, which may be presented on the control device after selection of the “Add” selectable element of the pair notification 1710 (as indicated in FIG. 17 by dashed arrow 18). Pairing of the wearable playback device with the control device can include various steps and/or operations, which will be described in more detail hereinafter with reference to FIGS. 21 and 22. For instance, the pairing process can include different steps and/or operations depending on whether the wearable playback device has previously been initially configured with a different control device, or whether the wearable playback device has been previously activated and/or registered, etc.

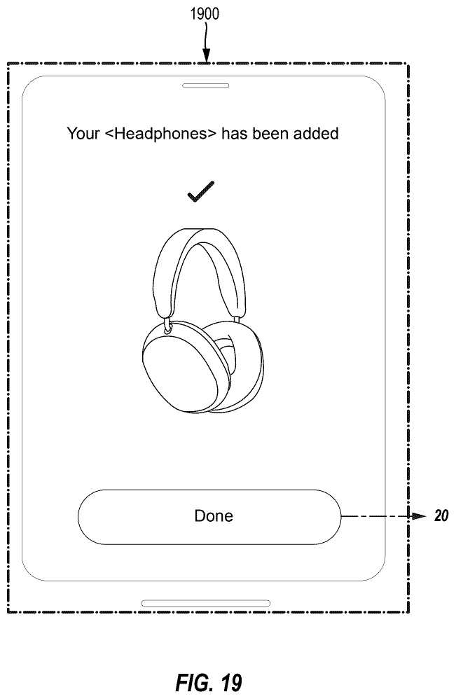

FIG. 19 illustrates a graphical user interface display showing a completion presentation 1900 indicating that pairing of the wearable playback device with the control device is complete. The completion presentation 1900 includes a “Done” selectable element that can be selected by users to cause the control device to navigate to or present a media dashboard interface 2000 as depicted in FIG. 20.

The media dashboard interface 2000 can enable management and/or control of playback devices that have been added to a media playback system associated with the user account active on the control device and/or that have been paired with the control device. For instance, the media dashboard interface 2000 shown in FIG. 20 includes product elements 2010 associated with various playback devices that have been added to the media playback system associated with the user account active on the control device. In some implementations, the playback devices associated with the product elements 2010 each include a network interface 112d (e.g., to enable a Wi-Fi connection between the playback device and a network 104 that is not dependent on a pairwise connection with the control device). The media dashboard interface 2000 shown in FIG. 20 also includes a portables element 2020 associated with the wearable playback device paired with the control device as described with reference to FIGS. 17 through 19. In some implementations, the wearable playback device associated with the portables element 2020 omits a network interface 112d (e.g., instead utilizing a pairwise connection with the control device, such as a Bluetooth connection). The media dashboard interface 2000 can thus comprise a single interface or control suite that enables users to manage and/or control (i) playback devices having independent network access (e.g., “network-based playback devices” associated with the product elements 2010) and (ii) wearable playback devices that utilize pairwise connections (e.g., the wearable playback device associated with the portables element 2020). For instance, a user may provide control input to cause synchronized playback of media content on both network-based playback devices and the wearable playback device, or a user may provide control input to cause playback swapping among the wearable playback device and the network-based playback devices (as described above with reference to FIG. 6).

Similar to the media dashboard interface 1700 shown in FIG. 17, the media dashboard interface 2000 includes an “Add Product” selectable element and an “Add Headphones” selectable element, which can enable users to initiate adding of additional network-based playback devices and/or wearable playback devices for association with the control device and/or the media playback system associated with the user account active on the control device.

FIGS. 21 and 22 are example operational flow diagrams 2100 and 2200, respectively, showing data exchanges and/or operations of various entities, in accordance with the disclosed subject matter. Although operations and/or data exchanges may be shown and/or described with reference to FIGS. 21 and 22 in a particular order, no specific ordering is required unless explicitly stated or unless performance of one operation relies on completion of another. Furthermore, one will appreciate, in view of the present disclosure, that one or more operations and/or data exchanges shown in flow diagrams 2100 and/or 2200 may be omitted in certain instances and/or embodiments (e.g., where a data gap occurs, or where network or other connectivity is lost).

The various entities shown in flow diagram 2100 include a user 2102, a wearable playback device 2104, a control device 2106, a product registration system 2108, and a cloud settings system 2110. The wearable playback device 2104 may comprise a type of playback device 110 as described hereinabove. The control device 2106 may comprise a type of control device 130 as described hereinabove. The product registration system 2108 and the cloud settings system 2110 may comprise or reside on computing systems (e.g., one or more servers or computing device(s) 106) that are remote from the control device 2106 (e.g., that are in communication with the control device 2106 via a wide-area network) and may therefore be regarded as “remote systems”. The product registration system 2108 may be a system which maintains a database of registered and/or activated wearable playback devices. The cloud settings system 2110 can store settings and/or tokens associated with a particular user account and wearable playback devices configured using the particular user account.

Flow diagram 2100 depicts data exchanges and/or operations associated with initial configuration of the wearable playback device 2104 with the control device 2106 (and/or a user account that is active on the control device). At block 2112, the user 2102 provides user input that triggers launching or running of a media application on the control device 2106. For instance, a user may select an icon 700 (see FIG. 7) on a user interface of the control device 2106 to cause the media application to launch. The media application may be adapted to facilitate pairing of the wearable playback device 2104 with the control device 2106. The media application may further be able to control playback of media content using the wearable playback device 2104 (and/or other playback devices).

At block 2114, the user powers on the wearable playback device 2104. At block 2116, the wearable playback device 2104 emits an advertisement signal that is detectable by the control device 2106. In some instances, the advertisement signal indicates whether the wearable playback device 2104 has already been initially configured or previously paired with a control device (e.g., control device 2106 or another control device). In some instances, the advertisement signal indicates whether the wearable playback device 2104 has been previously registered or activated. The communications from the wearable playback device 2104 to the control device 2106 (and vice-versa) may utilize any suitable wireless communication protocol, such as a Bluetooth protocol (e.g., Bluetooth Low Energy (BLE)) or another pairwise (or peer-to-peer) connection protocol.

At block 2118, the wearable playback device 2104 enters a pairing mode (e.g., automatically or after receiving user input). At block 2120, the control device 2106 presents a pair notification on a display thereof (or on another user interface or I/O element thereof). The pair notification can indicate that the wearable playback device 2104 is available for pairing with the control device 2106. The pair notification can comprise a pop-up notification or card or a setup wizard. The pair notification can generally correspond to the pair notification 1710 shown and described with reference to FIG. 17.

At block 2122, the control device 2106 initiates pairing of the wearable playback device 2104 with the control device 2106 (e.g., after receiving user input or automatically). At block 2124, a two-way wireless connection or communication channel (e.g., a BLE connection) is established between the wearable playback device 2104 and the control device 2106. As part of establishing the two-way wireless connection or communication channel, the wearable playback device and control device can exchange keys to create a trusted communication channel or link. At block 2126, an attestation process is performed involving the wearable playback device 2104 and the control device 2106. The attestation can indicate that the wearable playback device 2104 corresponds to a genuine product (i.e., the product is authorized for use with the particular media application). For instance, the attestation can involve a handshake in which the wearable playback device 2104 sends a manufacturing certificate to the control device 2106 to enable the control device 2106 to verify that the wearable playback device 2104 is a genuine product.

At block 2128, an authentication is performed involving the wearable playback device 2104 and the control device 2106. Through the authentication process, the control device can be granted different access levels for the wearable playback device 2104. The authentication can involve a handshake in which the wearable playback device 2104 conveys one or more tokens to the control device 2106. The token(s) can comprise data objects or pieces of data (e.g., authentication tokens) used to manage the ability of the control device 2106 (and/or other control devices) to control functions of the wearable playback device 2104. For example, tokens that can be transmitted from the wearable playback device 2104 to the control device 2106 can include (i) a primary access token, (ii) an issuer token, and/or (iii) a common access token. The wearable playback device 2104 can be configured to generate new primary access tokens, issuer tokens, and/or common access tokens upon factory reset.

The primary access token can enable the control device 2106 to control primary functions in addition to common functions of the wearable playback device 2104, such as, by way of non-limiting example, diagnostics, voice control settings, usage data access or sharing (e.g., allowing users to opt-in to usage data collection or telemetry frameworks), or playback device swapping (as described above with reference to FIG. 6). The primary functions of the wearable playback device 2104 can be different from common functions of the wearable playback device 2104. Example common functions can include media playback (play, pause, scrub, playback speed, etc.), audio settings (e.g., noise cancellation settings, audio balance, etc.), media content selection, and/or others. The issuer token can be exchanged for a primary access token. For instance, after receiving the issuer token from a control device, the wearable playback device 2104 can determine the validity of the issuer token by, for example, comparing with the issuer token that the wearable playback device generated after factory reset and/or with the issuer token stored in the memory of the wearable playback device. Based on determining that the issuer token is a valid token, the wearable playback device can send a primary access token to a requesting control device, as described in more detail hereinbelow.

When the wearable playback device 2104 is being initially configured (e.g., after a factory reset, or where the advertisement signal of block 2116 indicates that the wearable playback device 2104 has not been initially configured or associated with a user account), block 2128 can include transmitting an issuer token and a primary access token to the control device 2106 from the wearable playback device 2104, enabling the control device 2106 to control primary functions of the wearable playback device 2104. Block 2128 may occur only after a successfully logging into a user account on the control device 2106. In some instances, the primary access token also enables the control device 2106 to control common functions of the wearable playback device 2104 in addition to primary functions. In some instances, both a common access token and a primary access token are provided to the control device 2106 upon initial configuration of the wearable playback device 2104 to enable the control device 2106 to control both primary and common functions of the wearable playback device 2104.

In some implementations, both an issuer token and a primary access token are received by the control device 2106 when a user account (as described above with reference to FIGS. 9 through 20) is active on the control device 2106, thereby causing the wearable playback device 2104 to become associated with the active user account. At block 2130, where the control device 2106 received both an issuer token and a primary access token with an active user account, the control device 2106 communicates the issuer token over a network (e.g., network 102, accessible to the control device 2106 via a wide-area network) to the cloud settings system 2110 for storage in a data repository in association with the active user account. In this way, after initial configuration of the wearable playback device 2104 and when a user pairs the wearable playback device 2104 with a different control device on which the same user account is active, block 2128 and/or block 2130 can include the different control device obtaining the issuer token from the cloud settings system 2110 and providing the issuer token to the wearable playback device 2104. For example, after successfully logging into a user account on the control device, the control device 2106 may send a request to the cloud settings system 2110 to obtain at least one token (e.g., issuer token, primary token, common access token) associated with the particular user account in the cloud settings system 2110. After receiving the issuer token from the different control device (e.g., and determining that the issuer token received is valid, such as by comparing the received issuer token to the issuer token generated by the wearable playback device after factory reset), the wearable playback device 2104 can provide a primary access token to the different control device, thereby enabling the different control device to also control primary functions of the wearable playback device 2104. The issuer token can thus operate as a means for control devices that are subsequently paired with an already configured wearable playback device (e.g., a wearable playback device that has completed the initial configuration process) to receive a primary access token (without factory resetting the wearable playback device).

In contrast, when a user pairs the wearable playback device 2104 with a control device on which the applicable user account is inactive, block 2128 can include transmitting a common access token from the wearable playback device 2104 to the control device (e.g., while refraining from transmitting the issuer token and/or the primary access token), thereby enabling the control device to only control common functions of the wearable playback device 2104. In some instances, block 2128 involves conveying a common access token to the control device when no user account is active on the control device during initial configuration, setup, or pairing of the wearable playback device 2104 (e.g., where the user selects “Not now” to proceed without a user account, as described hereinabove with reference to FIG. 11). A token-based framework including common access tokens, primary access tokens, and issuer tokens as described herein can thus facilitate multi-controller access to the wearable playback device 2104, as well as differentiated access levels to functions of the wearable playback device 2104. If a user account becomes active on the control device after the control device receives a common access token, the control device can return to block 2128 and/or 2130 to obtain an issuer token and/or primary access token.

At block 2132, a registration is performed involving the wearable playback device 2104, the control device 2106, and the product registration system 2108. In the example shown in FIG. 21, the registration includes the control device 2106 sending a registration request to the product registration system 2108, triggering an additional attestation to indicate that the wearable playback device 2104 is a genuine product (block 2134). Block 2134 can include the product registration system 2108 returning a registration data packet to the control device 2106 for transmission to the wearable playback device 2104. The wearable playback device 2104 may sign the data packet (e.g., using the manufacturing certificate) to form a signed or attested registration data packet, which the wearable playback device 2104 may return to the control device 2106 for transmission to the product registration system 2108. The product registration system 2108 may then record the wearable playback device 2104 as a registered product (e.g., in association with the user account active on the control device 2106).

Flow diagram 2200 of FIG. 22 depicts data exchanges and/or operations associated with multi-user access to the wearable playback device 2104. Flow diagram 2200 depicts the wearable playback device 2104, the control device 2106, and the cloud settings system 2110 shown and described with reference to flow diagram 2100 of FIG. 21. Flow diagram 2200 furthermore conceptually represents various blocks of flow diagram 2100 for initially configuring the wearable playback device 2104 using the control device 2106. For instance, arrow 2202 of flow diagram 2200 represents the performance of at least block 2128 (i.e., the authentication step) of flow diagram 2100, in which an issuer token and a primary access token are communicated from the wearable playback device 2104 to the control device 2106. FIG. 22 provides a legend 2204 indicating symbols associated with the issuer token (black diamond), the primary access token (white square), and the common access token (black circle). Arrow 2206 of flow diagram 2200 represents the performance of block 2130 of flow diagram 2100 in which the issuer token is transmitted to the 2110 for storage in a data repository in association with the user account active on the control device 2106 during the initial configuration of the wearable playback device 2104.

After initial configuration of the wearable playback device 2104 in association with the user account active on the control device 2106, and after storage of the issuer token on the cloud settings system 2110, other control devices on which the same user account is active may obtain the issuer token from the cloud settings system 2110 to request and receive a primary token from the wearable playback device 2104. Such functionality can enable the other control devices on which the user account is active to pair with the wearable playback device 2104 and, after the pairing, control the primary functions of the wearable playback device 2104 (e.g., without factory resetting the wearable playback device 2104).

For instance, flow diagram 2200 includes additional control devices 2208A and 2208B, on which the same user account used by the control device 2106 to initially configure the wearable playback device 2104 is also active. Arrows 2210A and 2210B of flow diagram 2200 conceptually depict the control devices 2208A and 2208B obtaining the issuer token from the cloud settings system 2110, which was previously transmitted to the cloud settings system 2110 by control device 2106 pursuant to initial configuration/pairing of the wearable playback device 2104. The additional control devices 2208A and 2208B may obtain the issuer token from the cloud settings system 2110 via a request, or the issuer token may be pushed to the additional control devices 2208A and/or 2208B automatically (e.g., upon login of the applicable user account on the additional control devices 2208A and/or 2208B), which may occur before, after, or while pairing the wearable playback device 2104 with the additional control devices 2208A and/or 2208B.

Flow diagram 2200 also includes arrows 2212A and 2212B, which conceptually depict the additional control devices 2208A and 2208B sending primary access requests to the wearable playback device 2104. The primary access requests include the issuer token received by the additional control devices 2208A and 2208B from the cloud settings system 2110. After receiving the primary access request, the wearable playback device 2104 may send the primary access token to the additional control devices 2208A and 2208B (indicated in flow diagram 2200 by arrows 2214A and 2214B), which may enable the additional control devices 2208A and 2208B to control primary functions of the wearable playback device 2104. The additional control devices 2208A and/or 2208B may additionally perform other operations associated with connecting to the wearable playback device 2104 (e.g., attestation or registration steps and/or others shown and described with reference to flow diagram 2100).

As noted above, a control device may become paired with the wearable playback device 2104 without a user account active on the control device (e.g., where a user elected to proceed with connection of a control to the wearable playback device 2104 without creating a user account, as described above with reference to FIG. 11). This may occur whether or not the wearable playback device 2104 has been initially configured, set up, or paired with another control device or user account previously. Similarly, a control device may become paired with the wearable playback device 2104 with a different user account active thereon (i.e., a different user account than the one used to initially configure the wearable playback device 2104). Flow diagram 2200 depicts control device 2216, on which no user account is active, or on which a different user account than the one used to initially configure the wearable playback device 2104 is active. For example, the control device 2216 may comprise a guest device. Arrow 2218 of flow diagram 2200 conceptually depicts pairing of the control device 2216 with the wearable playback device 2104, where the authentication step (e.g., corresponding to block 2128 of flow diagram 2200) includes transmitting a common access token to the control device 2216. The common access token enables the control device 2216 to control common functions of the wearable playback device 2104 (e.g., playback, audio, and/or media selection functions) while refraining from enabling the control device 2216 to control primary functions of the wearable playback device 2104.

In instances, where the wearable playback device 2104 is initially paired with a control device 2216 on which no user account is active, the registration step (e.g., block 2132 of flow diagram 2100) may be replaced with an activation step, in which (i) the control device 2216 sends an activation request to the product registration system 2108, (ii) the product registration system 2108 returns an activation data packet to the control device 2216, (iii) the control device 2216 sends the activation data packet to the wearable playback device 2104 for attestation (e.g., with the manufacturing certificate), and (iv) the control device receives an attested activation packet and sends the same to the product registration system 2108 to record the wearable playback device 2104 as having been activated. Activation can indicate that the wearable playback device 2104 has paired with a control device but is not associated with any particular user account.

In some implementations, after activation of a wearable playback device 2104, the wearable playback device 2104 becomes connected to a control device on which a user account is active. When pairing to such a device, the advertisement signal emitted by the wearable playback device 2104 can indicate whether the wearable playback device 2104 has been previously activated or registered (or neither). When advertisement signal indicates that the wearable playback device 2104 has been previously activated, and when a user account is active on the control device connected to the wearable playback device 2104, the control device may send a conversion request to the product registration system 2108 to cause the product registration system 2108 to change the recorded status of the wearable playback device 2104 from activated to registered in association with the user account.

In some instances, after the control device 2216 has received a common access token from the wearable playback device 2104, the user account associated with the wearable playback device 2104 may become active on the control device 2216 (e.g., via a login process), which may enable the control device 2216 to obtain the issuer token from the cloud settings system 2110 and request a primary access token from the wearable playback device 2104 (e.g., following operations similar to those described hereinabove for additional control devices 2208A and 2208B).

### IV. Features

The disclosed technology is illustrated, for example, according to various features described below. Various examples of features of the disclosed technology are described as numbered features (1, 2, 3, etc.) for convenience. These are provided as examples and do not limit the disclosed technology. It is noted that any of the dependent features may be combined in any combination, and placed into a respective independent features. The other features can be presented in a similar manner.
Feature 1. A method for a device, the method comprising: initiating pairing of a wearable playback device with the device, including receiving, from the wearable playback device, a primary access token and an issuer token, wherein the primary access token enables the device to control one or more primary functions of the wearable playback device in addition to one or more common functions of the wearable playback device, wherein the issuer token is configured to cause the wearable playback device to send a primary access token to other devices that provide the issuer token to the wearable playback device; and transmitting the issuer token over a network to cause storage of the issuer token in a data repository.
Feature 2. The method of feature 1, further comprising, before receiving the primary access token and the issuer token, and after detecting an advertisement signal emitted by a wearable playback device, presenting a pair notification on a user interface of the device and detecting a user input at a user interface of the device directed to initiating pairing of a wearable playback device with the device, wherein the pair notification indicates that the wearable playback device is available for pairing with the device.
Feature 3. The method of feature 2, wherein the advertisement signal indicates that the wearable playback device has not been initially configured.
Feature 4. The method of any preceding feature, further comprising, before receiving the primary access token and the issuer token, receiving, from the wearable playback device, an attestation indicating that the wearable playback device comprises a genuine product.
Feature 5. The method of feature 4, wherein the attestation comprises a manufacturing certificate for verification by the device.
Feature 6. The method of any preceding feature, further comprising, before receiving the primary access token and the issuer token: sending a product registration request to a remote system; receiving, from the remote system, a registration data packet; sending the registration data packet to the wearable playback device; receiving, from the wearable playback device, an attested registration data packet; and sending the attested registration data packet to the remote system to register the wearable playback device.
Feature 7. The method of feature 6, wherein the attested registration data packet is signed with a manufacturing certificate.
Feature 8. The method of any preceding feature, wherein the one or more primary functions comprise one or more of: diagnostics, voice control settings, usage data access or sharing, or playback device swapping.
Feature 9. The method of any preceding feature, wherein the one or more common functions comprise one or more of: media playback, audio settings, or media content selection.
Feature 10. The method of any preceding feature, wherein the wearable playback device comprises headphones or earbuds.
Feature 11. The method of any preceding feature, wherein the issuer token is stored in association with the user account in the data repository.
Feature 12. A method for a system comprising the device of one of features 1 to 11 and a second device, the method comprising, sending, by the second device to a wearable playback device that has been configured with a different device, an issuer token, and receiving, by the second device from the wearable playback device, a primary access token that enables the second device to control one or more primary functions of the wearable playback device in addition to one or more common functions of the wearable playback device.
Feature 13. The method of feature 12, wherein the second device is associated with the user account.
Feature 14. The method of feature 12, wherein the issuer token is received by the second device from one of: the first device; and a data repository comprising the issuer token stored in association with the user account.
Feature 15. The method of feature 12, wherein, when the user account is not active on the second device, initiating paring of the wearable playback device comprises receiving, from the wearable playback device, a common access token, wherein the common access token enables the device to control one or more common functions of the wearable playback device.
Feature 16. A method for a device the method comprising: initiating pairing of a wearable playback device that has been initially configured with a different device, including sending an issuer token received by the device from a data repository over a network, the issuer token being previously generated by the wearable playback device and transmitted to the different device; and after sending the issuer token to the wearable playback device, receiving, from the wearable playback device, a primary access token, wherein the primary access token enables the device to control one or more primary functions of the wearable playback device in addition to one or more common functions of the wearable playback device.
Feature 17. The method of feature 16, further comprising: before sending the issuer token, receiving a user input at a user interface of the device directed to initiating pairing of the wearable playback device with the device.
Feature 18. The method of one of features 16 and 17, wherein, when the user account is inactive on the device, the device receives, from the wearable playback device, a common access token, wherein the common access token enables the device to control one or more common functions of the wearable playback device.
Feature 19. The method of one of features 16 to 18, further comprising before receiving the primary access token or the common access token: receiving, from the wearable playback device, an attestation indicating that the wearable playback device comprises a genuine product.
Feature 20. The method of feature 19, wherein the attestation comprises a manufacturing certificate for verification by the device.
Feature 21. The method of one of features 16 to 20, further comprising, before receiving the primary access token: when the user account is active on the device: sending a product registration request to a remote system; receiving, from the remote system, a registration data packet; sending the registration data packet to the wearable playback device; receiving, from the wearable playback device, an attested registration data packet; and sending the attested registration data packet to the remote system to register the wearable playback device; and when the user account is inactive on the device: sending a product activation request to a remote system; receive, from the remote system, an activation data packet; sending the activation data packet to the wearable playback device; receiving, from the wearable playback device, an attested activation data packet; and sending the attested activation data packet to the remote system to activate the wearable playback device.
Feature 22. The method of feature 21, wherein the attested registration data packet or the attested activation data packet is signed with a manufacturing certificate.
Feature 23. The method of one of features 16 to 22, further comprising, before initiating pairing with the wearable playback device, receiving an advertisement signal from the wearable playback device indicates whether the wearable playback device has been previously registered or activated.
Feature 24. The method of one of features 16 to 23, further comprising: when the advertisement signal indicates that the wearable playback device has been previously activated and when the user account is active on the device: sending a conversion request to the remote system to register the wearable playback device.
Feature 25. The method of one of features 16 to 24, wherein the one or more primary functions comprise one or more of: diagnostics, voice control settings, usage data access or sharing, or playback device swapping.
Feature 26. The method of one of features 16 to 24, wherein the wearable playback device comprises headphones or earbuds.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

What is currently claimed is:

1. A computing device, comprising:
at least one processor; and
at least one non-transitory computer-readable recording medium comprising program instructions that are executable by the at least one processor such that the computing device is configured to:
after detecting an advertisement signal emitted by a wearable playback device, present a pair notification on a user interface of the computing device, wherein the pair notification indicates that the wearable playback device is available for pairing with the computing device;
initiate configuration of the wearable playback device;
after initiating configuration of the wearable playback device, receive user input at the user interface to initiate pairing of the wearable playback device with the computing device; and
after initiating configuration of the wearable playback device with the computing device:
receive, from the wearable playback device, a primary access token and an issuer token, wherein the primary access token enables the computing device to control one or more primary functions of the wearable playback device, wherein the one or more primary functions of the wearable playback device are different from one or more common functions of the wearable playback device; and
transmit the issuer token over a network to cause storage of the issuer token in a data repository in association with a user account.

2. The computing device of claim 1, wherein the advertisement signal indicates that the wearable playback device requires initial configuration.

3. The computing device of claim 1, wherein the at least one non-transitory computer-readable recording medium further comprises program instructions that are executable by the at least one processor such that the computing device is configured to:
after initiating pairing of the wearable playback device with the computing device and before receiving the primary access token and the issuer token:
receive, from the wearable playback device, an attestation indicating that the wearable playback device comprises a genuine product.

4. The computing device of claim 3, wherein the attestation comprises a manufacturing certificate for verification by the computing device.

5. The computing device of claim 1, wherein the at least one non-transitory computer-readable recording medium further comprises program instructions that are executable by the at least one processor such that the computing device is configured to:
after initiating pairing of the wearable playback device with the computing device:
send a product registration request to a remote system;
receive, from the remote system, a registration data packet;
send the registration data packet to the wearable playback device;
receive, from the wearable playback device, an attested registration data packet; and
send the attested registration data packet to the remote system to register the wearable playback device.

6. The computing device of claim 5, wherein the attested registration data packet is signed with a manufacturing certificate.

7. The computing device of claim 1, wherein the one or more primary functions comprise one or more of: diagnostics, voice control settings, usage data access or sharing, or playback device swapping.

8. The computing device of claim 1, wherein the one or more common functions comprise one or more of: media playback, audio settings, or media content selection.

9. The computing device of claim 1, wherein the wearable playback device comprises headphones or earbuds.

10. A computing device, comprising:
at least one processor; and
at least one non-transitory computer-readable recording medium comprising program instructions that are executable by the at least one processor such that the computing device is configured to:
after detecting an advertisement signal emitted by a wearable playback device, present a pair notification on a user interface of the computing device, wherein the advertisement signal indicates that the wearable playback device has been initially configured with a different computing device in association with a user account, wherein the pair notification indicates that the wearable playback device is available for pairing with the computing device; and
after receiving user input at the user interface directed to initiating pairing of the wearable playback device with the computing device:
when the user account is active on the computing device:
send a primary access request to the wearable playback device, wherein the primary access request includes an issuer token received by the computing device from a data repository over a network, the issuer token being generated by the wearable playback device and transmitted to the data repository via the different computing device; and
receive, from the wearable playback device, a primary access token, wherein the primary access token enables the computing device to control one or more primary functions of the wearable playback device.

11. The computing device of claim 10, wherein the at least one non-transitory computer-readable recording medium further comprises program instructions that are executable by the at least one processor such that the computing device is configured to:
after receiving the user input at the user interface directed to initiating pairing of the wearable playback device with the computing device:
when the user account is inactive on the computing device, receive, from the wearable playback device, a common access token, wherein the common access token enables the computing device to control one or more common functions of the wearable playback device.

12. The computing device of claim 11, wherein the at least one non-transitory computer-readable recording medium further comprises program instructions that are executable by the at least one processor such that the computing device is configured to:
after receiving the user input at the user interface directed to initiating pairing of the wearable playback device with the computing device and before receiving the primary access token or the common access token:
receive, from the wearable playback device, an attestation indicating that the wearable playback device comprises a genuine product.

13. The computing device of claim 12, wherein the attestation comprises a manufacturing certificate for verification by the computing device.

14. The computing device of claim 11, wherein the at least one non-transitory computer-readable recording medium further comprises program instructions that are executable by the at least one processor such that the computing device is configured to:
after receiving the user input at the user interface directed to initiating pairing of the wearable playback device with the computing device:
when the user account is active on the computing device:
send a product registration request to a remote system;
receive, from the remote system, a registration data packet;
send the registration data packet to the wearable playback device;
receive, from the wearable playback device, an attested registration data packet; and
send the attested registration data packet to the remote system to register the wearable playback device; and
when the user account is inactive on the computing device:
send a product activation request to a remote system;
receive, from the remote system, an activation data packet;
send the activation data packet to the wearable playback device;
receive, from the wearable playback device, an attested activation data packet; and
send the attested activation data packet to the remote system to activate the wearable playback device.

15. The computing device of claim 14, wherein the attested registration data packet or the attested activation data packet is signed with a manufacturing certificate.

16. The computing device of claim 14, wherein the advertisement signal indicates whether the wearable playback device has been previously registered or activated.

17. The computing device of claim 14, wherein the at least one non-transitory computer-readable recording medium further comprises program instructions that are executable by the at least one processor such that the computing device is configured to:
when the advertisement signal indicates that the wearable playback device has been previously activated and when the user account is active on the computing device:
send a conversion request to the remote system to register the wearable playback device.

18. The computing device of claim 11, wherein the one or more primary functions comprise one or more of: diagnostics, voice control settings, usage data access or sharing, or playback device swapping.

19. The computing device of claim 11, wherein the one or more common functions comprise one or more of: media playback, audio settings, or media content selection.

20. A computing device, comprising:
at least one processor; and
at least one non-transitory computer-readable recording medium comprising program instructions that are executable by the at least one processor such that the computing device is configured to:
after receiving user input directed to initiating configuration of a wearable playback device:
receive, from the wearable playback device, a primary access token and an issuer token, wherein the primary access token enables the computing device to control one or more primary functions of the wearable playback device, wherein the one or more primary functions of the wearable playback device are different from one or more common functions of the wearable playback device; and
transmit the issuer token over a network to cause storage of the issuer token in a data repository in association with a user account.
